(19) United States
(12) Patent Application Publication
(10) Pub. No.: US 2008/0088499 A1
(43) Pub. Date: Apr. 17, 2008

(54) METHODS AND APPARATUS FOR HYPERVIEW AUTOMOTIVE RADAR

(76) Inventors: Andrew J. Bonthron, Los Angeles, CA (US); Gerald Juskovic, Newport Beach, CA (US)

Correspondence Address: BARCELO & HARRISON, LLP, 22091 WOOD ISLAND LANE, HUNTINGTON BEACH, CA, 92646, US

(21) Appl. No.: 11/752,245

(22) Filed: May 22, 2007

Related U.S. Application Data
(60) Provisional application No. 60/808,275, filed on May 24, 2006.

(51) Int. Cl. G01S 13/02

(52) U.S. Cl. 342/104; 342/118

(57) ABSTRACT

Methods and apparatus are presented that reduce the overall system cost for automotive radar sensing applications. In accordance with aspects of the present invention, one way sensor count reduction can be achieved is through the coverage of multiple vehicle sides through a single sensor. One embodiment combines all high-frequency signal sensor components with an antenna network which are together separately housed as an antenna unit. Each antenna unit transmits high-frequency radar signals and receives and down-converts reflected portions of said transmitted signal. The low-frequency down-converted signals produced by each antenna unit are processed through a shared processing unit which may be separately housed from all antenna units or commonly housed with an antenna unit. In addition, methods for effectively utilizing a sensor comprising multiple antenna units are described according to aspects of the present invention. Other methods and apparatus are presented.

### RELATED APPLICATIONS

This application is related to and claims priority to U.S. Provisional Application No. 60/808,275, filed May 24, 2006, which is incorporated herein by reference.

### BACKGROUND OF THE INVENTION

1. Technical Field of the Invention

The subject matter disclosed generally relates to the field of automotive electronic systems and methods. More specifically, the subject matter disclosed relates to radar sensor arrangements that allow cost reduction for automotive radar collision avoidance and driver aid applications.

2. Background of Related Art

To facilitate mass deployment of automotive radar sensors, reducing the total system cost per vehicle without compromising the capability, performance, or reliability of the system is desirable. Automotive short-range sensing applications typically aim to provide a complete or nearly complete surrounding coverage around a vehicle, with target range, velocity, and angular resolution capability, and the ability to discriminate between multiple targets as required in near-distance driving scenarios. One way to reduce the system cost is to reduce the number of radar sensors necessary to provide the required coverage area and functionality for automotive collision avoidance and driving aid applications. One way this can be accomplished is through the creation of a radar sensor unit having a wide angular field of view coverage such that a single sensor can provide coverage for a single vehicle side. FIG. 1 illustrates one exemplary reduced sensor count configuration and coverage regions that are possible for short-range radar applications by utilizing a radar architecture and method providing a wide angular field-of-view. In this arrangement, a vehicle 400 uses four sensor units 420a, 420b, 420c, 420d to cover the front, rear, left and right side quadrants of the vehicle to provide a nearly complete surround coverage. Similarly, for vehicle applications requiring less than four quadrant coverage, fewer sensors can be used, resulting in a lower system cost.

Further reduction of cost could be implemented by increasing the field of view of a sensor so that multiple vehicle sides can be covered by a single sensor. One method to provide this capability is to implement separately housed antenna networks as antenna units and to mount each of these antenna units on a vehicle and to provide an interface for each of these antenna units to a processing unit.

### BRIEF SUMMARY OF THE INVENTION

Methods and apparatus are presented that reduce the overall system cost for automotive radar sensing applications. In accordance with aspects of the present invention, one way sensor count reduction can be achieved is through the coverage of multiple vehicle sides through a single sensor. One embodiment combines all high-frequency signal sensor components with an antenna network which are together separately housed as an antenna unit. Each antenna unit transmits high-frequency radar signals and receives and down-converts reflected portions of said transmitted signal. The low-frequency down-converted signals produced by each antenna unit are processed through a shared processing unit which may be separately housed from all antenna units or commonly housed with an antenna unit. In addition, methods for effectively utilizing a sensor comprising multiple antenna units are described according to aspects of the present invention. Other methods and apparatus are presented.

Other aspects and advantages of the present invention can be seen upon review of the figures, the detailed description, and the claims which follow.

### BRIEF DESCRIPTION OF THE DRAWINGS

The accompanying drawings are for the purpose of illustrating and expounding the features involved in the present invention for a more complete understanding, and not meant to be considered as a limitation, wherein:

FIG. 1A is a diagram illustrating a sensor arrangement for automotive sensor applications using radar sensors according to aspects of the present invention.

FIG. 2A is a block diagram illustrating features of one embodiment of a radar sensor architecture according to aspects of the present invention.

FIG. 2B is a block diagram illustrating features of one embodiment of a radar sensor architecture according to aspects of the present invention.

FIG. 3A is a block diagram illustrating features of one embodiment of a radar sensor architecture according to aspects of the present invention.

FIG. 3B is a block diagram illustrating features of one embodiment of a radar sensor architecture according to aspects of the present invention.

FIG. 3C is a block diagram illustrating features of one embodiment of a radar sensor architecture according to aspects of the present invention.

FIG. 3D is a block diagram illustrating features of one embodiment of a radar sensor architecture according to aspects of the present invention.

FIG. 4A is a diagram illustrating features of one embodiment of an antenna unit according to aspects of the present invention.

FIG. 4B is a diagram illustrating features of one embodiment of an antenna unit according to aspects of the present invention.

FIG. 4C is a diagram illustrating features of one embodiment of an antenna unit according to aspects of the present invention.

FIG. 4D is a diagram illustrating features of one embodiment of an antenna unit according to aspects of the present invention.

FIG. 5 is a diagram illustrating features of one embodiment of spatially separated antennas according to aspects of the present invention.

FIG. 6A is a diagram illustrating features of one embodiment of an antenna unit according to aspects of the present invention.

FIG. 6B is a diagram illustrating features of one embodiment of an antenna unit according to aspects of the present invention.

FIG. 6C is a diagram illustrating features of one embodiment of an antenna unit according to aspects of the present invention.

FIG. 7A is a block diagram illustrating features of one embodiment of a downconverted signal processor according to aspects of the present invention.

FIG. 7B is a block diagram illustrating features of one embodiment of a downconverted signal processor according to aspects of the present invention.

FIG. 7C is a block diagram illustrating features of one embodiment of a downconverted signal processor according to aspects of the present invention.

FIG. 8A illustrates an output waveform from the stepped frequency transmit signal generator 790 in accordance with one embodiment of the present invention.

FIG. 8B illustrates an output waveform from the stepped frequency transmit signal generator 790 in accordance with another embodiment of the present invention.

FIG. 8C illustrates an output waveform from PRI modulation signal generator 791 in accordance with one embodiment of the present invention.

FIG. 9 is a diagram illustrating an example of antenna unit selection timing according to aspects of the present invention.

FIG. 10A is a diagram illustrating an example of receiver antenna selection timing according to aspects of the present invention.

FIG. 10B is a diagram illustrating an example of A/D converter sample timing according to aspects of the present invention.

FIG. 11A is a diagram illustrating an example of vehicle placement of antenna units and/or processing antenna unit on a vehicle according to aspects of the present invention.

FIG. 11B is a diagram illustrating another example of vehicle placement of antenna units and/or processing antenna unit on a vehicle according to aspects of the present invention.

FIG. 11C is a diagram illustrating yet another example of vehicle placement of antenna units and/or processing antenna unit on a vehicle according to aspects of the present invention.

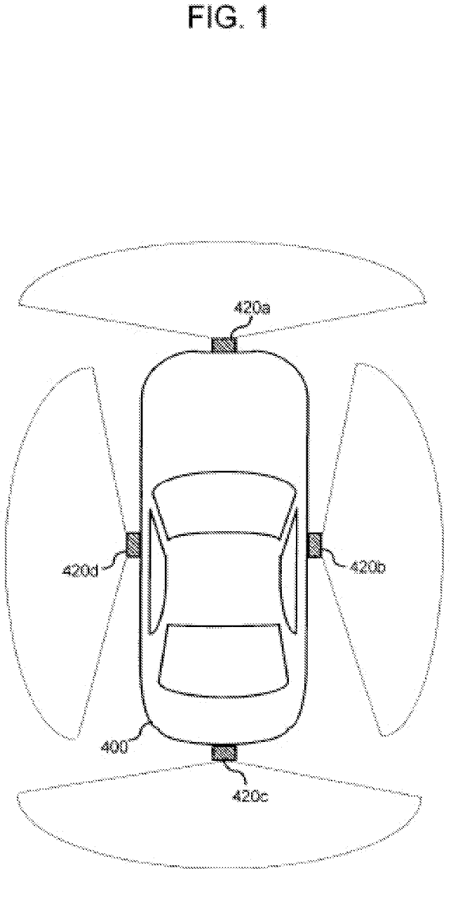

### DETAILED DESCRIPTION

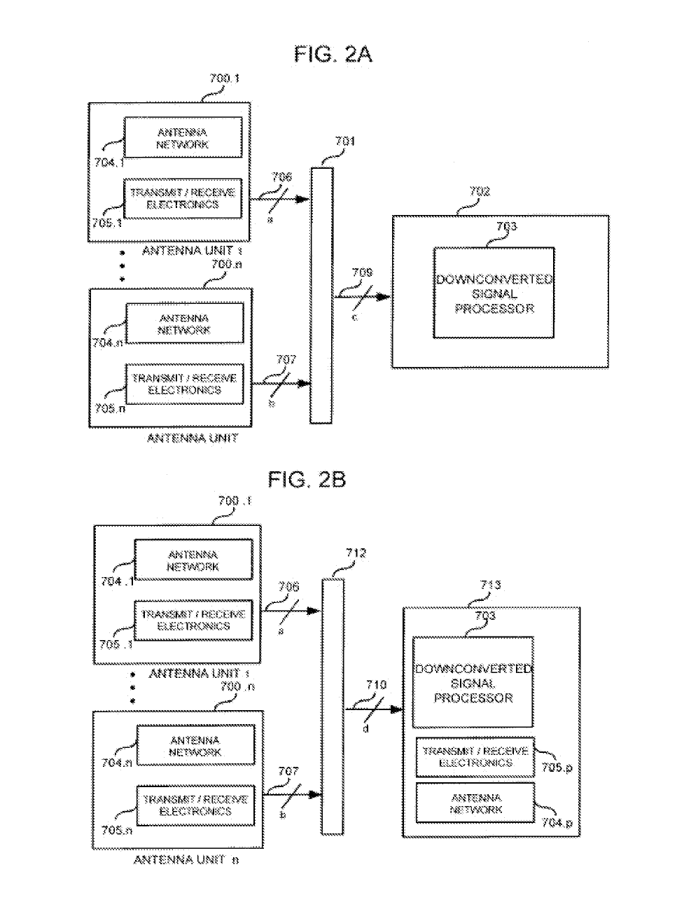

FIG. 2A illustrates an embodiment of a radar sensor according to aspects of the present invention. The radar sensor consists of a plurality of antenna units 700.1 through 700.n, a processing unit 702 and an interface means 701. In this arrangement, antenna units 700.1, 700.n each include an antenna network 704.1, 704.n for transmitting radar signals and for receiving reflected portions of said transmitted radar signal. Antenna networks 704.1, 704.n each produce one or a plurality of transmit beam shapes and one or a plurality of receive beam shapes that are utilized to implement one or a plurality of detection zones for each antenna unit 700.1, 700.n, whereby a detection zone is determined by the region of overlap between transmit and receive beams utilized for target detection. The number and types of beam shapes and detection zones may vary for different antenna units 700.1, 700.n for advantage. The total area covered by all detection regions for each antenna unit 700.1, 700.n is the coverage area for an antenna unit 700.1, 700.n. Antenna units with wide angular coverage can enable the reduction of the number of antenna units required to cover a single side or to enable the ability to reduce the number of antenna units required to cover multiple vehicle sides. For example, with a sufficiently wide angular coverage, one sensor incorporating four antenna units may enable a single radar sensor to cover all four vehicle sides. To provide coverage for a vehicle side it is desirable that an antenna unit have the ability in combination with a processing unit to determine target direction or the ability to determine the presence of a target within at least one of a plurality of detection zones or a combination of the two abilities. In addition, an antenna unit/processing unit combination has the ability to determine target range. An antenna network may be implemented to produce a plurality of concurrent and/or sequentially received signals.

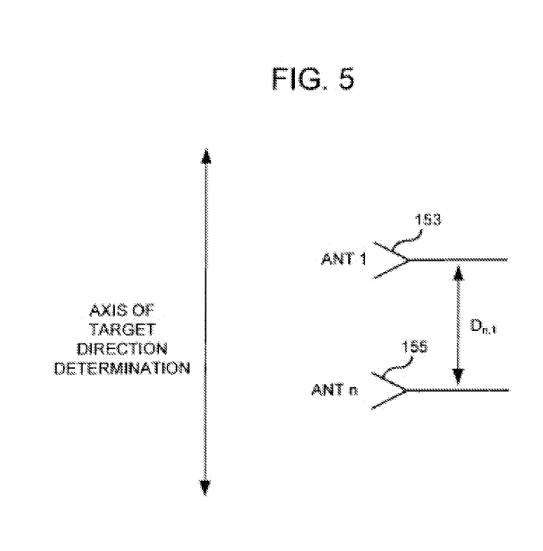

One such antenna network embodiment utilizes a plurality of spatially separated antennas, as illustrated in FIG. 5, whereby the antennas are spatially separated in the axis of target direction and produces a plurality of spatially separated signals for processing by receiver electronics. Said spatially separated antennas may be utilized, for example but not meant as any limitation, for a signal transmission antenna network, for a signal reception antenna network, for both signal transmission and reception antenna networks, or for an antenna network that utilizes shared transmit/receive spatially separated antennas. Referring to FIG. 2A, transmit/receive electronics 705.1, 705.n down-convert received reflected portions of said transmitted radar signals to produce one or a plurality of concurrent down-converted signals 706, 707, for processing and analysis by processing unit 702. The number of concurrent channels may differ or be identical for each antenna unit 700.1, 700.n. In addition, antenna units 700.1, 700.n may vary the number of concurrent down-conversion channel signals produced over time for advantage. An antenna unit may also only include transmit means whereby another antenna unit would include receive means. Processing unit 702 includes means for detecting the presence of a target range within one or a plurality of detection zones by processing said down-converted signals through the downconverted signal processor electronics 703. It may also have the ability to determine target direction from an antenna unit by processing said down-converted signals through the downconverted signal processor electronics 703.

Generally, not meant as any limitation, the frequency of a down-converted signal in such an arrangement is less than 100 MHz. This low-frequency enables interface means 701 to be implemented as a low-cost interface medium for transmitting antenna units' down-converted signals 706, 707 to the processing unit 702. In addition, the interface means 701 may include wireless transmission of down-converted signals from the antenna units 700.1, 700.n to the processing unit 702 as part of one embodiment the present invention. In the configuration shown, at least two antenna units are utilized. Antenna units 700.1, 700.n are separately housed and mounted on a vehicle from processing unit 702. In an embodiment of the present invention, down-converted signals from at least two antenna units are separately processed in a time-sequenced manner by down-converted signal processor 703, thus enabling the sharing of processing resources and thereby enabling lower overall system cost. Numerous methods exist for controlling said time sequencing or time interleaving that can be implemented by those ordinarily skilled in the art.

FIG. 2B Illustrates another embodiment of the present invention. FIG. 2B is a modification of FIG. 2A, whereby transmit/receive electronics 705.p and antenna network 704.p, are combined with processing unit 702 to implement a processing antenna unit 713 whose components are commonly housed and may be separately mounted on a vehicle from antenna units 700.1, 700.n. At least one antenna unit is utilized in this configuration. For any antenna unit network, a separate processing unit may be utilized or a processing antenna unit may be used in place of one of the antenna units.

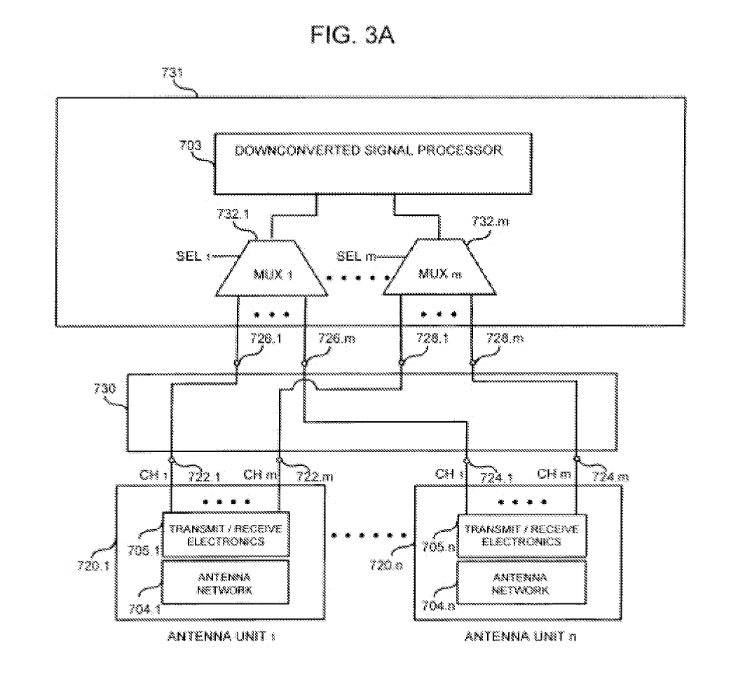

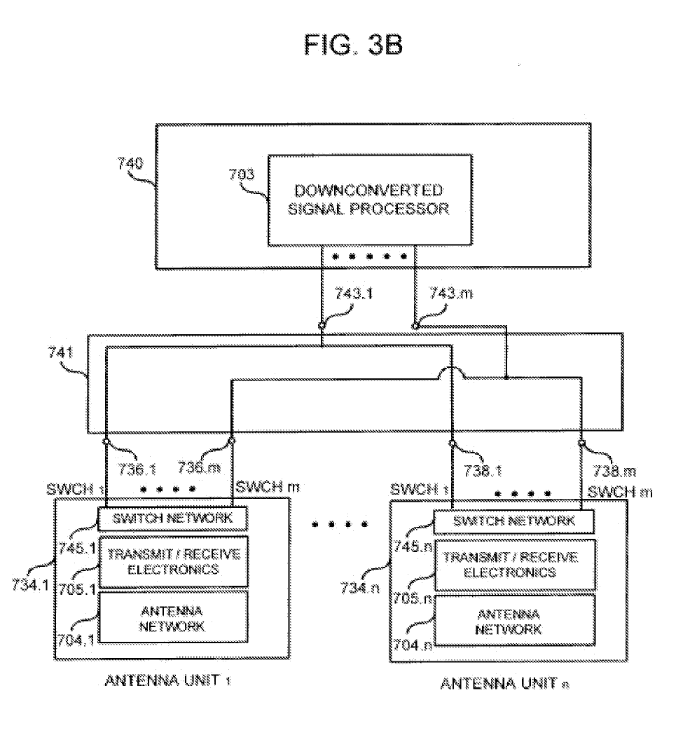

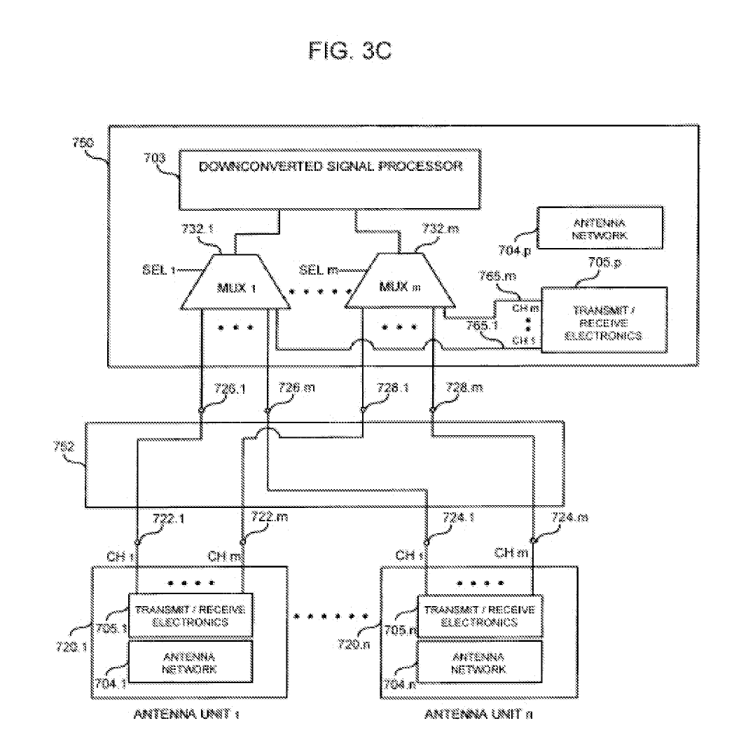

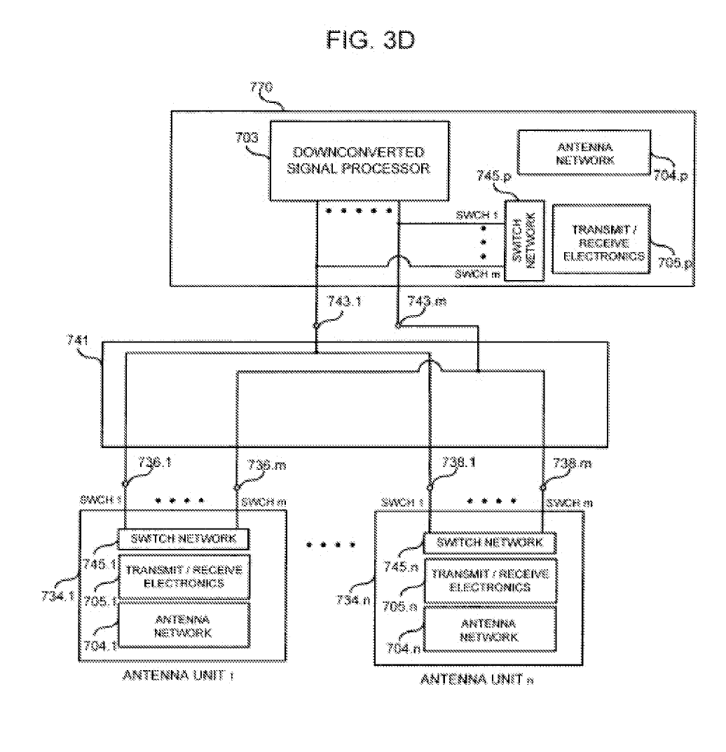

FIG. 3A illustrates yet another embodiment of the present invention. Antenna units 720.1, 720.n illustrate embodiments of antenna units 700.1, 700.n, described earlier. In this embodiment, access to the down-converted signals produced through concurrent down-conversion channels CH 1 through CH m by the transmit/receive electronics 705.1, 705.n are directly provided through external connection points 722.1, 722.m, 724.1 and 724.m. Processing unit 731 is one embodiment of processing unit 702, described earlier. Processing unit 731 includes downconverted channel multiplexers (“muxes”) 732.1, 732.m for selecting down-converted channels from antenna units 720.1, 720.m for processing by downconverted signal processor 703. Interface means 730 is one embodiment of interface means 701 (described earlier) for the configuration shown.

In this embodiment, the number of downconverted channel selection muxes 732.1, 732.m corresponds to the number of down-conversion channels, m, for each antenna unit 720.1, 720.m. The number of down-converted channel input lines connected to each down-converted channel selection muxes, 732.1, 732.m, is equal to the number of antenna units, n, in this embodiment. Each downconverted channel selection mux 732.1, 732.m selects a down-converted channel signal from one antenna unit to provide for processing by down-converted signal processor 703. In the embodiment shown, the down-converted channel selection muxes 732.1, 732.m, not meant as any limitation, may select down-converted channel signals from a single antenna unit for a period of time for processing by down-converted signal processor 703, before selecting downconverted channel signals from another antenna unit. Alternate down-converted channel signal selection configurations may be utilized for advantage. In the embodiment shown, each antenna unit 720.1, 720.m produces m down-converted channel signals. However, the number of down-converted channel signals may differ for any antenna unit. The number of downconverted channel selection muxes can correspondingly be modified as needed.

For example, in a two antenna unit configuration, if one antenna unit produces an additional ‘b’ concurrent down-converted channels as compared to the other antenna unit, the ‘b’ additional channels may, for example, be directly connected to down-converted signal processor 703 without being selected by a mux. Furthermore, the type of muxes and configuration of muxes may be varied. For example, not meant as any limitation, the multiple muxes utilized in this embodiment may be replaced by a single n by m input and m output mux. Furthermore, not all or any of the downconverted channel selection muxes 732.1, 732.m need to be incorporated in processing unit 731. For example, not meant as any limitation, some or all of the muxes may be distributed in one antenna unit 720.1, 720.n or distributed among multiple antenna units 720.1, 720.n. One example utilizes a “daisy chain” type configuration wherein a mux is incorporated within an antenna unit and the channel outputs from another antenna unit is provided to the former antenna unit. This antenna unit then utilizes the mux to select between its own down-converted signals and that of the other antenna unit to provide to another antenna unit with similar mux integration or to the processing unit through connection means.

FIG. 3B illustrates another embodiment of the present invention as an alternative to utilizing a mux for downconverted channel selection. In this embodiment, antenna units 734.1, 734.n include switch networks 745.1, 745.n which are utilized by antenna units 734.1, 734.n for determining which down-converted channel signals will be transferred to their corresponding connection points 736.1, 736.m, 738.1, 738.m. Corresponding down-converted channel signal connection points are connected to a common line. For example, not meant as any limitation, the channel-1 down-converted signal outputs from all antenna units may be connected to a commonly shared line. In this configuration, switch networks 745.1, 745.n enable only one down-converted channel signal to be applied to a common line at a time, thus providing an alternative down-converted channel selection means to the utilization of muxes as in FIG. 3A. In the embodiment shown, antenna units 734.1, 734.n produce the same number, “m”, of down-converted channel signals. However, the number of down-converted channel signals may differ for any antenna unit 734. For example, in a two antenna unit configuration, if one antenna unit produces ‘b’ more concurrent down-converted channels as compared to another antenna unit 734, the ‘b’ additional channels do not need to be selected through a switch and can be, for example, directly connected to the downconverted signal processor 703. Not meant as any limitation, the embodiment shown can also be varied in other ways. For example, it is not necessary that a common line have commonly numbered channels from antenna units 734, such as all down-converted channel-1 signal points, connected to the same common line. Furthermore, the configuration shown can be implemented in a daisy chain manner whereby the downconverted channel outputs from one antenna unit are provided through its switch network to common points within another antenna unit. The switch network in each antenna unit determines which antenna unit's signals are applied to common connection points which may be internal or external to an antenna unit. The selected down-converted channel signals can be provided to another antenna unit for similar operation, can provide downconverted channel signals to the processor unit through a commonly shared line or can provide downconverted channel signals to a processor unit through non-shared lines.

FIG. 3C illustrates another embodiment of the present invention. FIG. 3C is similar to FIG. 3A, except that in this case antenna unit elements are combined with processing unit 731 (as in FIG. 3A) as a processing antenna unit 750, which is commonly housed and mounted on a vehicle. At least one antenna unit is utilized in this configuration.

FIG. 3D illustrates yet another embodiment of the present invention. FIG. 3D is similar to FIG. 3B, except that in this case antenna unit elements are combined with processing unit 740 (as in FIG. 3B) as a processing antenna unit 770 and is commonly housed and separately mounted on a vehicle from antenna units 734.1, 734.n. At least one antenna unit is utilized in this configuration. Hybrid switched output/mux selection embodiments of FIG. 3A-3D may be implemented as embodiments of the present invention.

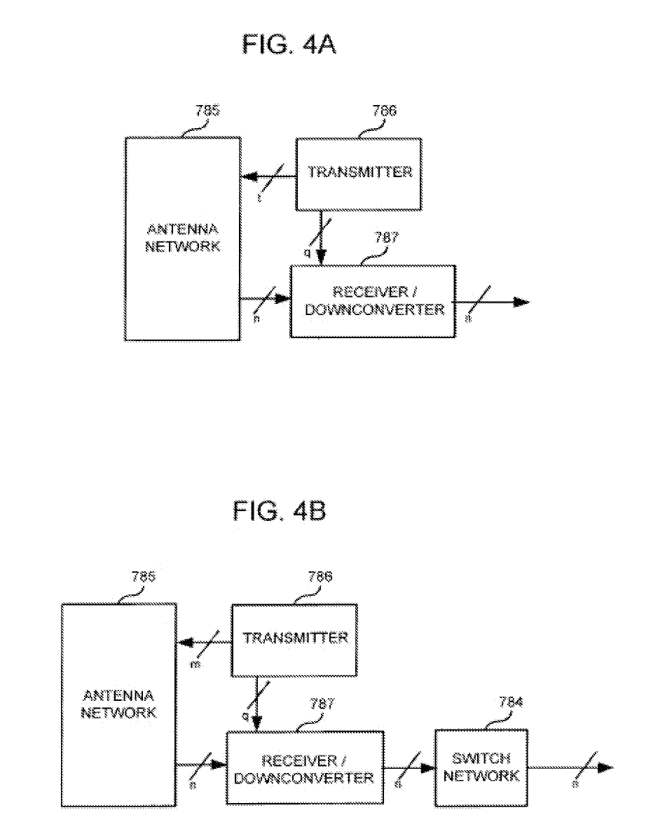

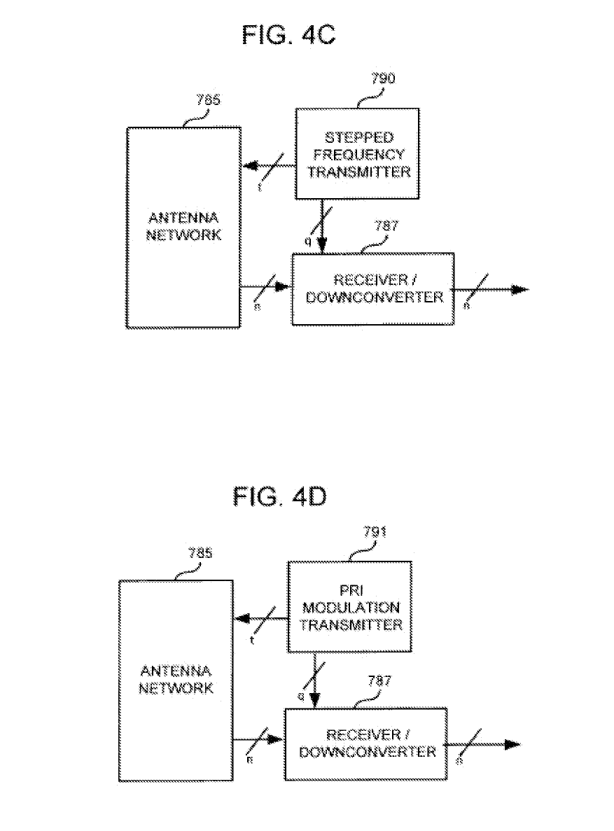

FIG. 4A illustrates one embodiment of previously described antenna units 700.1, 700.n, 720.1, 720.n. In this arrangement, transmitter 786 outputs ‘t’ signals to antenna network 785 for electromagnetic emission, where t is an integer greater than or equal to 1. A typical frequency of the output signal emitted from the transmitter 786 can be within, but is not limited to, the frequency range of 22 GHz-29 GHz or 76 GHz-81 GHz. The reflected signal from a target will be received by antenna network 785, which outputs n signals to a receiver/down-converter 787, where n is an integer greater than or equal to 1. The receiver/down-converter 787 also accepts q signals from transmitter 786, where q is an integer greater than or equal to 1, and outputs one or a plurality of signals generated through comparison of components of the emitted signal and components of the corresponding received reflected signal from a target.

The receiver/down-converter can utilize one or a plurality of individual down-conversion channels in generating the output comparison signals. The transmitter 786 can include, but is not limited to, generation of one or a plurality of linearly frequency modulated signals, linearly stepped frequency signals, transmit pulsing signal generation or pulsed frequency modulated signals. The antenna network 785 signal transmission means can include, but is not limited to, a single antenna, a plurality of antennas, a plurality of spatially separated antennas, or one or a plurality of groups of spatially separated antennas with one or a plurality of antennas simultaneously selected for emission of one or a plurality of signals. Antenna network 785 may contain antenna elements utilized for creating multiple detection zones.

Furthermore, not meant as any limitation, these detection zones may be directed in a common direction or a plurality of directions. Antenna network 785 signal receiving means may include, but is not limited to, a single antenna, a plurality of antennas, a plurality of spatially separated antennas, or one or a plurality of groups of spatially separated antennas with one or a plurality of antennas simultaneously selected for reception of one or a plurality of signals. Antenna network 785 may contain antenna elements utilized for creating multiple detection zones. Furthermore, not meant as any limitation, these detection zones may be directed in a common direction or a plurality of directions. Either or both transmit and receiving antenna means may include switching means for selecting one of a plurality of individual transmit and/or receiver antenna means for connection to a single transmit signal or to a single down-conversion channel for a period of time prior to selecting another individual transmit and/or receiver antenna means. Furthermore, transmit and receive antennas can be combined such that one or more antennas can be time-shared for both transmitting and receiving functions.

FIG. 4B illustrates another embodiment of antenna unit 500. This configuration is the same as FIG. 4A, with the addition of switch network 784 to enable or disable the application of down-converted channel output signals to a common line, as shown in FIGS. 3B and 3D. Switch network 784 may similarly be added to FIGS. 4A, 4C and 4D.

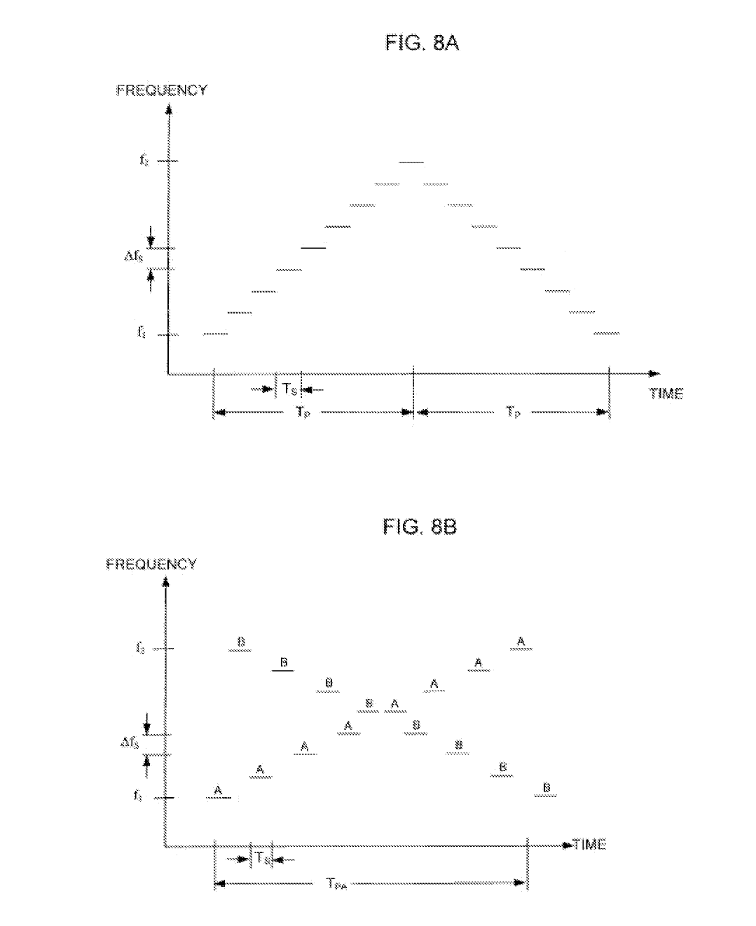

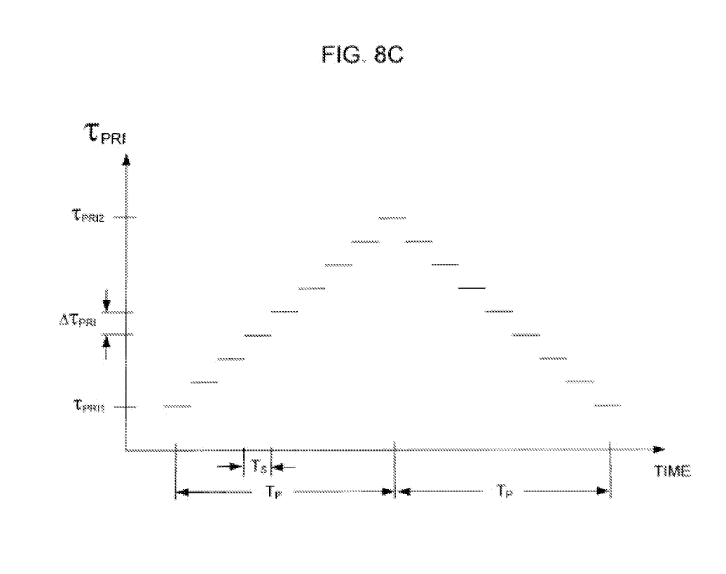

FIG. 4C illustrates another embodiment of FIG. 4A. This embodiment utilizes a stepped frequency transmitter 790 to generate a transmission signal. The stepped frequency signal 790 may include, but is not limited to, generation of transmission signals such as those shown in FIGS. 8A, 8B. Various configurations of stepped frequency transmitter 790 may be implemented such as, but not limited to, pulsing of the transmitted stepped signal so that a stepped frequency pulsed signal is generated for advantage. Furthermore, FIG. 4C may be modified to include switch network 784 as in FIG. 4B.

FIG. 4D illustrates yet another embodiment of FIG. 4A. This embodiment utilizes a PRI modulation transmitter 791, whereby the time interval between transmitted pulses is modified to generate a transmission signal. The PRI modulation transmitter 791 may include, but is not limited to, generation of a transmission signal such as shown in FIG. 8C. FIG. 4D may be modified to include switch network 784, as in FIG. 4B.

One example of antenna spatial separation is illustrated in FIG. 5 according to aspects of the present invention. The example of antenna spatial separation shown in FIG. 5 is for illustration purposes and is not considered a limitation. In this arrangement, n antennas, including antennas 153, 155 are separated from one another by a distance D_{n,1} in the axis of target direction determination. For antennas that are not aligned in the axis of direction determination, the spatial separation between elements is the distance between them when projected onto the axis of direction determination. The axis of direction determination can be, but is not limited to, the azimuth or the elevation axis. In the example illustrated in FIG. 5, n is an integer greater than or equal to 2. The distances between adjacent antennas for the situation where n is 3 or greater need not be equal.

Spatially separated antennas may be used within antenna networks 704.1, 704.n, 704.p, according to aspects of the present invention. Not meant as any limitation, spatially separated signals may, for example, be created by spatially separated antenna utilized for transmission, for reception, for both transmission and reception or as shared antennas used for both transmission and reception. If spatially separated antennas are utilized for transmission, generally only one spatially separated transmit antenna is selected at a time for signal transmission. If both spatially separated receive and transmission antenna are utilized, through proper spacing of antennas, the number of spatially separated signals that can be generated is the product of the number of spatially separated receive antennas multiplied by the number of spatially separated transmission antennas. To enable high-accuracy determination of a target's direction relative to an antenna unit, generally three or more spatially separated signals are utilized and concurrently processed utilizing one or more direction finding algorithms by signal processor 300.

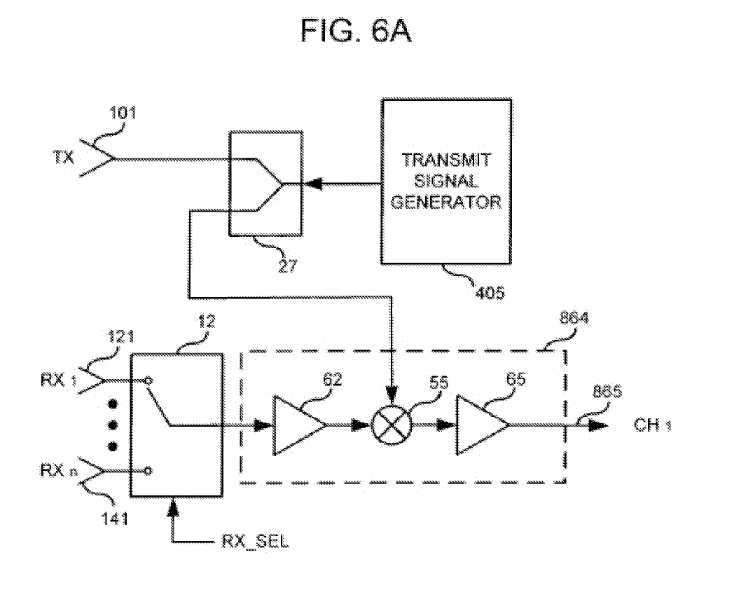

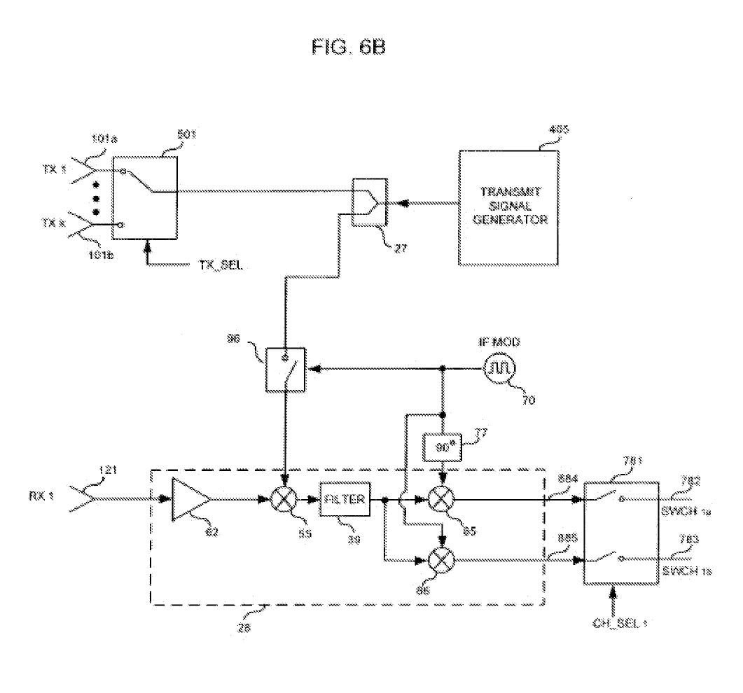

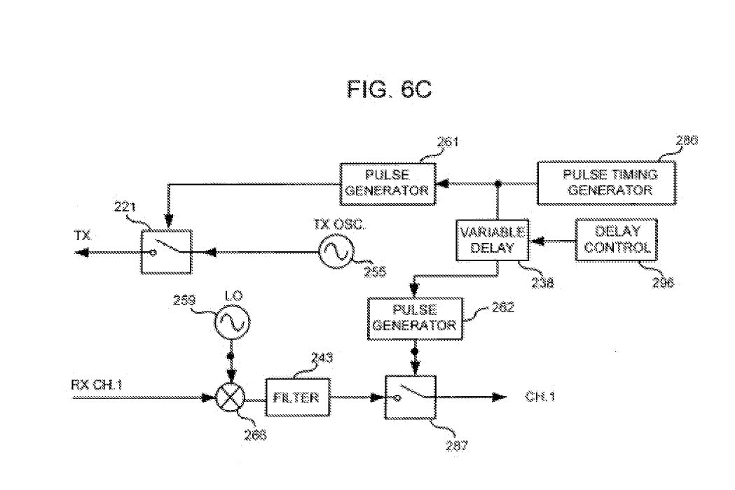

FIG. 6A illustrates aspects of one embodiment of the antenna units shown in FIG. 4A, 4B, 4C, 4D, not meant as any limitation. In this arrangement, a transmit signal generated by the transmit signal generator 405 is split by a signal splitter 27, where one portion of the signal proceeds to an antenna means 101 for transmission of the signal towards a target. A typical frequency of the output signal from the transmit signal generator 405 can be within, but is not limited to, the frequency range of 22 GHz-29 GHz or 76 GHz-81 GHz. The reflected signal from a target is received by an array of n receiver antennas 121, 141, designated by RX 1, RX n, where n is an integer greater than or equal to 2. A selection switch 12 is used to selectively connect one receiver antenna at a time with the antenna unit's single receiver/down-converter channel 864 in a sequential manner. The selection switch is controlled by a signal designated as RX_SEL. The receiver/down-converter channel for the antenna unit consists of a low-noise amplifier 62, where the received signal is amplified prior to being input to down-converting mixer 55, where the signal is mixed with one output signal from signal splitter 27, and the resulting signal is amplified by amplifier 65. A single down-converter channel, 864, is implemented in the configuration shown. The antenna unit configuration shown can be utilized within invention embodiments shown in FIGS. 3A, 3C and 3E.

The block diagram shown in FIG. 6A can be modified according to aspects of the present invention. For example, Channel-1 output signal, 864, may be fed to an output enable switch to enable utilization in invention embodiments FIGS. 3B and 3D. Furthermore, switch 12 may be removed and a single receive antenna may be utilized. Another modification, not meant as a limitation, can be to replace mixer 55 with an I/Q complex mixer for complex signal down-conversion and modify the block diagram accordingly. A further example of such a modification, not meant as a limitation, can be to replace the selection switch 12 with a plurality of switched amplifiers and signal combiners, utilizing the gain/loss of the switched amplifiers to realize an antenna selection and routing function. A yet further example of such a modification, not meant as a limitation, can be to share an RX antenna with the TX antenna function, or to utilize a plurality of switched TX antennas in combination with the switched RX antennas to synthesize a receive antenna array. Other transmit and receiver antenna implementations may be utilized without departing from the spirit of the present invention.

Another modification is to gate the transmitted signal, the received signal or both the transmitted and receive signals. An additional modification, not meant as a limitation, can be to modulate the received signal or local oscillator signal input to mixer 55 by an intermediate frequency, then add an additional down-conversion mixing stage to achieve final baseband signal down-conversion. Mixer 55 can be implemented by, but is not limited to, a mixer, multiplier, or switch without changing the basic functionality of the arrangement. Signal splitter 27 can be implemented by, but is not limited to, a Wilkinson power divider, passive splitter, active splitter, or microwave coupler. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention. In addition, any combination of the described modifications or their equivalents can be used in combination without departing from the spirit of the present invention.

An antenna unit arrangement is presented in FIG. 6B as a further embodiment of the present invention. The arrangement in FIG. 6B utilizes intermediate-frequency (“IF”) modulation of a local oscillator signal combined with transmit antenna selection switching element 501, illustrating that the use of switched spatially separated transmission antennas to create spatially separated received signals and includes additional down-conversion circuitry used to create in-phase (I) and quadrature (Q) signals prior to signal AID conversion. The IF modulation frequency of IF modulator 70 is used to control the local oscillator modulator 96, creating an intermediate frequency offset signal from the local oscillator frequency which is input to mixer 55 to mix with the received signal. The result is the creation of intermediate frequency signal components after the mixer 55. The output signal from mixer 55 is then down-converted to the baseband I/Q signals 884, 885 using mixers 85, 86. To more clearly illustrate functionality, most amplifiers have been omitted from the antenna unit architecture in FIG. 68. Through the use of this arrangement, noise associated with the down-conversion process can be improved. Switch 781 selects or de-selects the single channel, 786, paired I and Q down-converted channel signals, 884, 885. The antenna unit configuration shown can be utilized within invention embodiments shown in FIGS. 3B and 3D, whereby each switched point, 736.1, 736.m, 738.1 and 738.m may consist of a pair of signal lines representing the I and Q portions for each down-converted channel.

The block diagram shown in FIG. 6B can be modified according to aspects of the present invention. One example is to remove switch 781. In this case, the antenna unit may be utilized in the embodiments shown in FIG. 3A, 3C or 3F. For FIGS. 3A and 3C, I/Q pairs of signals would be selected by muxes 732.1, 732.m to produce to downconverted signal processor 703. Another example of such a modification, not meant as a limitation, can be to include a plurality of receiver/down-converter channels. Another example of such a modification, not meant as a limitation, can be to replace the selection switch 12 with a plurality of switched amplifiers and signal combiners, utilizing the gain/loss of the switched amplifiers to realize an antenna selection and routing function. A yet further example of such a modification, not meant as a limitation, can be to share an RX antenna with the TX antenna function, or to utilize a plurality of switched TX antennas in combination with the switched RX antennas to synthesize a receive antenna array. Modulator 96 can be implemented by a switch, bi-phase modulator, single-sideband modulator, amplitude modulator, or phase modulator as part of the present invention. Mixer 55 can be implemented by, but is not limited to, a mixer, multiplier, or switch without changing the basic functionality of the arrangement. Filter 39 can be implemented by, but is not limited to, a band-pass filter or low-pass filter. Filter 39 can also be removed from the arrangement without departing from the spirit of the present invention. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

In this arrangement, the transmit selection switch 501 directs the transmission signal to one of a plurality of spatially separated transmit antennas 101a, 101b. A signal TX_SEL is utilized to select which transmit antenna 101a, 101b the transmission signal is directed to. A receive antenna 121 directs a received signal to down-conversion circuitry. Through the use an IF modulation frequency and two-stage down-conversion, the noise associated with the down-conversion process can be reduced.

A pulsed radar transmitter-receiver arrangement is illustrated in FIG. 6C as one embodiment of an antenna unit, not meant as any limitation. In this arrangement, a pulse timing generator 286 outputs a timing signal to a pulse generator 261 and variable delay 238. The delay value of variable delay 238 is controlled by delay control 296. The output of the variable delay 238 is input to a pulse generator 262. The output of pulse generators 261, 262 can comprise, but is not limited to, a pseudo-random pulse pattern, a pulse-position modulated pattern, a PRBS (pseudorandom bit sequence) pulse pattern, a pseudo-noise pulse pattern, a randomized pulse pattern, a channelized pulse pattern, a pattern with pulse amplitudes according to a predetermined code, a pattern with pulse positions according to a predetermined code, or a pattern with a pulse repetition frequency (PRF) according to a predetermined value. A transmit oscillator 255 outputs a continuous wave (CW) signal to a pulse modulator 221 whose pulse modulation of the CW signal is controlled by the pulsed signal from pulse generator 261. The output signal from pulse modulator 221 is then sent for transmission. The received signal is input to a receiver channel. A local oscillator 259 inputs a CW signal to mixer 266, where it is mixed with the received signal. The output from mixer 266 is filtered by filter 243, then input to range gate 287. The modulator 221 can be implemented by, but is not limited to, a pulse modulator, amplitude modulator, bi-phase shift keyed modulator, phase modulator, switch, mixer, or AND gate.

Filter 243 can be implemented by, but is not limited to, a band-pass filter. Mixer 266 can be implemented by, but is not limited to, a mixer, multiplier, or switch without changing the basic functionality of the arrangement. Range gates 287 can be implemented by, but is not limited to, a switch, sampler, detector, mixer, or multiplier without changing the basic functionality of the arrangement. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention. Furthermore, the arrangement shown in FIG. 6C can be modified by one skilled in the art such that the receiver channel down-converts in quadrature, outputting quadrature IF signals, without changing the basic form or spirit of the invention. In addition, additional receiver channels may be added.

Using the radar arrangement illustrated in FIG. 6C, one method for determining target range, not meant in any way as a limitation, is to vary or sweep the time delay of variable delay 238, and to threshold detect the IF signal during this process. Peaks in the detected power or envelope of the IF signal that exceed a predetermined threshold represent target returns. When a target peak in the IF is detected, the corresponding value of the time delay of variable delay 238 is proportional to the target's range, and is used to calculate target range using the following equation:

$$R = \frac{c \cdot {T}_{D }}{2} \qquad ( 1 )$$

where R is the calculated target range, c is the speed of light in a vacuum, and TD is the value of the time delay of variable delay 238 at the time a target peak in the IF is detected. One way a target's relative velocity can be determined is through calculation from successive target range measurements over predetermined time intervals. The difference in range measured over a time interval can give an estimation of the target's relative velocity.

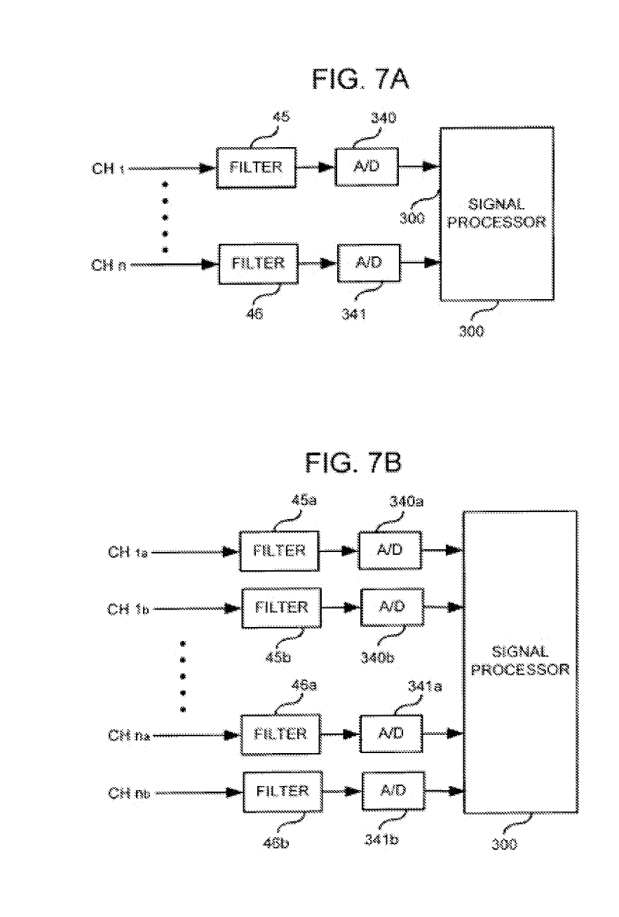

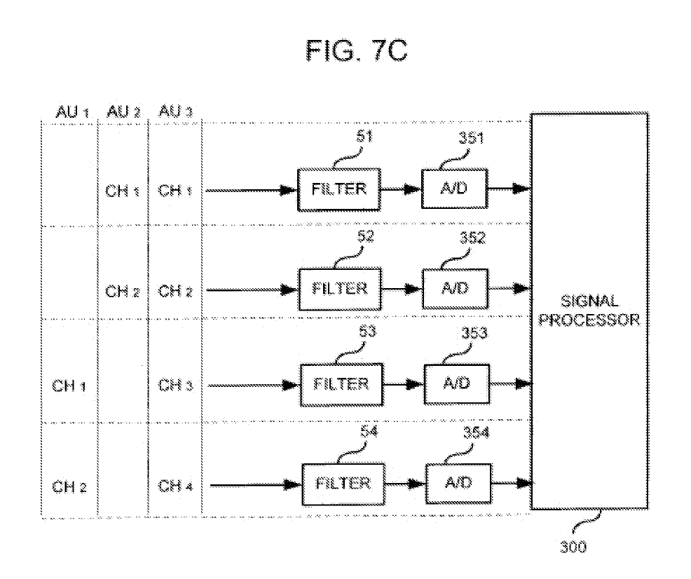

FIG. 7A illustrates one embodiment of downconverted signal processor 703. After filtering by filters 45, 46 the received down-converted channels CH 1, CH n are then digitized by analog-to-digital converters 340, 341 and input to a signal processor 300 for signal processing. Filters 45, 46 can be implemented by, but are not limited to, low-pass filters or band-pass filters. Filters 45, 46 may be omitted, depending on the requirements of each particular embodiment. Filters may also alternately be added to down-converted channel output signals of corresponding antenna units. Signal processor 300 may comprise a single or plurality of individual processors. Signal processor 300 may perform, but is not limited to, any single or combination of real or complex DFT or FFT signal processing, CFAR threshold detection, spectral peak detection, I/F peak detection, target peak association, frequency measurement, magnitude measurement, phase measurement, magnitude scaling, phase shifting, phase monopulse, amplitude monopulse, interferometry, spatial FFT processing, digital beam-forming (DBF) processing, digital multi-zone monopulse (DMM) processing, super-resolution processing, target angle calculation, target range calculation, and target velocity calculation.

Spatially separated signals processing may include, but is not limited to, phase monopulse, amplitude monopulse, interferometry, spatial FFT processing, digital beam-forming (DBF) processing, digital multi-zone monopulse (DMM) processing, or super-resolution algorithms such as multiple signal classification (MUSIC) or estimation of signal parameters via rotational invariance techniques (ESPRIT). Furthermore, spatially separated signal processing techniques can be used separately or in any combination, and can be combined with other techniques such as multilateration, or switched-beam detection zone discrimination for the purpose of improving angle calculation performance, reduction in false alarms, improvement in multiple target discrimination, reduction in clutter returns, or reduction in processor loading. In addition, different processing techniques may be used at different times or for different detections zones, target ranges, or for other advantage. Target angle calculation processing may include, but is not limited to, phase shifting, amplitude scaling, spectral peak phase measurement, spectral peak amplitude measurement, or spectral peak frequency measurement. Target range calculation processing may include, but is not limited to, spectral peak frequency measurement, spectral peak phase measurement, or signal envelope amplitude measurement. Target velocity calculation processing may include, but is not limited to, Doppler processing or derivation through successive time target measured positions. Target velocity derived from Doppler processing can also be used as a target discrimination means to aid in target separation and processing, especially in the situation where multiple target returns are from the same range or within the same range bin of the radar. Additional processing techniques used in the abovementioned functions may include, but are not limited to, windowing, digital filtering, Hilbert transform, least squares algorithms, or non-linear least squares algorithms. The signal processor may include, but is not limited to, a digital signal processor (DSP), microprocessor, microcontroller, electrical control unit, or other suitable processor block. Furthermore, target velocity can be determined externally from the radar sensor unit, such as in an external processor or on the radar system level, without departing from the spirit of the present invention.

If spatially separated antenna means are utilized, the spatially separated signals can be received using different receiver methods to provide multiple spatially separated received signals to a signal processor which utilizes spatially separated signals processing methods. Not meant as any limitation, spatial signal processing can be further combined with reception, and processing methods presented for stepped frequency and stepped PRI signals later described. Furthermore, through the utilization of antenna switching methods presented, multiple spatially separated signals can be received sequentially in time. Antenna switching methods enable a reduction of the number of required receiver channels as a receiver channel is shared by a plurality of spatially separated signals in time sequence, for a more compact, less expensive solution.

FIG. 7B is similar to FIG. 7A, except that it organized to receive pairs of I/Q down-converted signals, as for example are produced in FIG. 6B.

FIG. 7C illustrates one embodiment of a configuration of antenna unit down-converted channel inputs to a down-converted signal processor. In this configuration, rather than only selecting a single antenna unit at a time, antenna units AU₁ AU₂ may be selected simultaneously and time sequenced with AU₃.

FIGS. 7A-C may be implemented without filters without departing from the spirit of the current invention. In this case, filters may or may not be added to the down-conversion channels or the switch network shown in the embodiments in FIGS. 6A-C. For example, not meant as any limitation, a filter may be placed after amplifier 65 in FIG. 6A. Furthermore, FIGS. 7A-7B may additionally be implemented without A/D converters without departing from the spirit of the current invention. In this case, A/D converters would correspondingly be included in the antenna units. FIG. 3E is one embodiment of the present invention that may operate with such a configuration.

For all the above embodiments, synchronization means are required between antenna units and signal processing units. For example, not meant as any limitation, A/D sampling and signal processing may need to be synchronized with antenna unit output channel selection, with transmit and/or receive antenna switching as in but not limited to FIGS. 6A, 6B, and/or with stepped waveform transmission such as but not limited to FIGS. 8A, 8B, 8C. Furthermore, as different down-converted channels are selected from one or a plurality of antenna units for processing by downconverted signal processor 703, synchronization means between the antenna units and the processing unit is required. Furthermore, synchronization means may also be required in the case when A/D conversion is performed in an antenna unit. Numerous methods can be implemented for synchronization between antenna units and the signal processing unit and are well known to those skilled in the art. The low-frequency of the down-converted channel signals and of A/D sampling makes such synchronization relatively inexpensive, and facilitates implementation.

FIG. 8A illustrates a stepped-frequency modulation waveform for use in the stepped frequency transmitter 790 according to aspects of the present invention. This waveform shows a linearly stepped frequency pattern with a frequency increasing step sequence period and decreasing step sequence period each equal to Tₚ. This waveform shown is an example of linearly stepped frequency modulation and is not meant as a restriction. A typical value of Δfₛ can be within, but is not limited to, the range of 100 KHz-20 MHz. A typical value of Tₛ can be within, but is not limited to, the range of 500 nanoseconds (ns)-20 microseconds (μs). The waveform can also comprise, but is not limited to, a repeating pattern of linearly increasing frequency steps, a repeating pattern of linearly decreasing frequency steps, or alternating periods of linearly increasing and decreasing frequency step patterns. Also, periods where the stepped frequency modulation pattern is stopped may be inserted into the abovementioned patterns. In addition, the value of Tₛ may be varied or dithered, or the linearity of the frequency steps with respect to time may be slightly varied by one skilled in the art without departing from the spirit of the present invention.

Using the frequency modulation waveform shown in FIG. 8A, target information may be calculated from digitized down-converted signals in the following way. Peaks in the digitized down-converted signal spectrum represent target returns. The frequency of the target peaks is proportional to target range and is used to calculate target range. As an example, not meant in any way as a limitation, let the radar arrangement of FIG. 4C utilize a linearly increasing frequency step sequence and linearly decreasing frequency step sequence as shown in FIG. 8A. Let the down-converted signal be sampled and measured during each coherent measurement interval Tₚ, which for this example also corresponds to the frequency increasing step sequence period and decreasing step sequence period. Under these conditions, target range can be calculated by the following equation:

$$R = \frac{c \cdot {T}_{S}}{4 \cdot Δ {f}_{S}} \cdot ( {f}_{U} + {f}_{D} ) \qquad ( 2 )$$

where R is the calculated target range, c is the speed of light in a vacuum, Tₛ is dwell time of each frequency step, Δfₛ is the difference between adjacent frequency step values in the linear step sequence, and f_{U} and f_{D} are the beat frequencies in the down-converted signal corresponding to measurements during the frequency increasing sequence and frequency decreasing sequence periods T_{P} respectively.

The Doppler frequency shift of the target frequency peaks in measured across the digitized down-converted signal spectrum is used to calculate target relative velocity. As an example, not meant in any way as a limitation, let the radar arrangement of FIG. 4C utilize a linearly increasing frequency step sequence and linearly decreasing frequency step sequence as shown in FIG. 8A. Let the down-converted signal be sampled once per frequency step in each sequence, and measured during each coherent measurement interval T_{P}, which for this example also corresponds to the frequency increasing step sequence period and decreasing step sequence period. Under these conditions, target relative velocity can be calculated by the following equation:

$$V = \frac{c}{2 \cdot ( {f}_{1} + {f}_{2} )} \cdot ( {f}_{U} - {f}_{D} ) \qquad ( 3 )$$

where V is the calculated target relative velocity defined as positive for an approaching target, c is the speed of light in a vacuum, f₁ and f₂ are the minimum and maximum frequency steps in the linear sequence during a coherent measurement period T_{P}, and f_{U} and f_{D} are the beat frequencies in the digitized down-converted signal corresponding to the measurements during the frequency up-step sequence and down-step sequence periods T_{P} respectively. It should be noted that in order to determine target range and relative velocity without ambiguity, the use of measurements from both a frequency increasing step sequence period and decreasing step sequence period are required, as illustrated in equations (2) and (3). Thus, using the waveform illustrated in FIG. 8A, a time duration of 2*T_{P} is required to gather the measurement data required to determine a target's range and relative velocity, limiting the radar sensor's update period to greater than or equal to 2*T_{P}.

An alternate approach to calculating target range is to use an inverse fast Fourier transform (IFFT) or inverse discrete Fourier transform (IDFT), after sampling the down-converted signal, to build a target range profile. The peaks in the IFFT or IDFT profile represent target returns with range proportional to the peak's associated time bin.

FIG. 8B illustrates a stepped frequency modulation waveform for use in the stepped frequency transmitter 790 according to aspects of the present invention. This waveform comprises two linearly stepped frequency sequences intertwined, one having an equal but negative slope Δf_{S}/T_{S} with respect to the other the other, during a predetermined time interval.

Using the type of stepped frequency pattern shown in FIG. 8B, target information may be calculated from the digitized down-converted signals provided by A/D converters such as but not limited to FIGS. 7A, 7B, 7C in a manner similar to that as described for the frequency modulation pattern of FIG. 8A, with the exception that A/D samples of the down-converted signals must be correctly associated with their corresponding pattern A or B and de-intertwined before spectral processing such as, but not limited to, a Fourier transform or inverse Fourier transform. In this example, the two individual sequences A and B each have equal coherent processing interval durations T_{PA}=T_{PB}=T_{P}, with only the coherent processing interval T_{PA} for sequence A shown for clarity. Although the average frequency of both sequences A and B is shown to be the same in FIG. 8B, there may also be a shift in average frequency between sequences A and B. Also, the complex phase of each target spectral peak may be used for advantage in target data association and range-velocity ambiguity resolution. Furthermore, more than two sequences may be utilized, as well as more than one value of average frequency shift between sequences without departing from the spirit of the present invention.

One benefit of using intertwined waveforms such as but not limited to that shown in FIG. 8B is that only a period of approximately T_{PA} is required to gather the measurement data required to determine target range and relative velocity, improving the update rate of target range and relative velocity for the radar sensor as compared to the waveform illustrated in FIG. 8A. This reduced duration can be valuable for reducing the overall update period for the combination of antenna units in a sensor.

FIG. 8C illustrates a stepped PRI modulation waveform for use in the stepped PRI modulation signal generator 791 according to aspects of the present invention. This waveform shows a linearly stepped PRI pattern during a time period T_{P}. This waveform shown is an example of linearly stepped PRI modulation, and is not meant as a restriction. The waveform can also comprise, but is not limited to, a repeating pattern of linearly increasing PRI steps, a repeating pattern of linearly decreasing PRI steps, alternating periods of linearly increasing and decreasing PRI step patterns, or a plurality of intertwined linearly stepped PRI waveforms. Also, periods where the stepped PRI modulation pattern is stopped may be inserted into the abovementioned patterns.

Using the type of PRI modulation waveform described in FIG. 8C, target information may be calculated from the down-converted signals in the following way. Peaks in the down-converted signal spectrum represent target returns. The frequency of the target peaks is proportional to target range and is used to calculate target range. As an example, not meant in any way as a limitation, let the antenna unit arrangement of FIG. 4D transmit a single sideband, upper sideband radar signal and utilize a linearly increasing PRI step sequence and linearly decreasing PRI step sequence as shown in FIG. 8C. Let the digitized down-converted signals be measured during each coherent measurement interval T_{P}, which for this example also corresponds to the PRI increasing step sequence period and decreasing step sequence period. Under these conditions, target range can be calculated by the following equation:

$$R = \frac{c \cdot {T}_{S} \cdot Δ τ PRI}{4} \cdot ( {f}_{PU} + {f}_{PD} ) \qquad ( 4 )$$

where R is the calculated target range, c is the speed of light in a vacuum, T_{S} is dwell time of each PRI step, Δτ_{PRI} is the difference between adjacent PRI step values in the linear step sequence, and f_{PU} and f_{PD} are the beat frequencies in the digitized down-converted signal corresponding to measurements during the PRI increasing sequence and PRI decreasing sequence periods T_{P} respectively.

The Doppler frequency shift of the target frequency peaks is used to calculate target velocity. As an example, not meant in any way as a limitation, let the radar arrangement of FIG. 4D transmit a single sideband, upper sideband radar signal and utilize a linearly increasing PRI step sequence and linearly decreasing PRI step sequence as shown in FIG. 8C. Let the digitized down-converted signals be measured during each coherent measurement interval T_{P}, which for this example also corresponds to the PRI increasing step sequence period and decreasing step sequence period. Under these conditions, target relative velocity can be calculated by the following equation:

$$V = \frac{c}{4 {f}_{c} + 2 / {τ}_{PRI 1} + 2 / {τ}_{PRI 2}} \cdot ( {f}_{PU} - {f}_{PD} ) \qquad ( 5 )$$

where V is the calculated target relative velocity defined as positive for an approaching target, c is the speed of light in a vacuum, f_{C} is the frequency of the transmit oscillator 253, τ_{PRI1} and τ_{PRI2} are the minimum and maximum PRI values in the linear sequence during a coherent measurement period T_{P}, and f_{PU} and f_{PD} are the beat frequencies in the digitized down-converted signal corresponding to the measurements during the PRI up step sequence and down step sequence periods T_{P} respectively. Intertwined stepped frequency transmission signals can reduce update periods and time for antenna unit selection similarly as intertwined stepped frequency signal transmission.

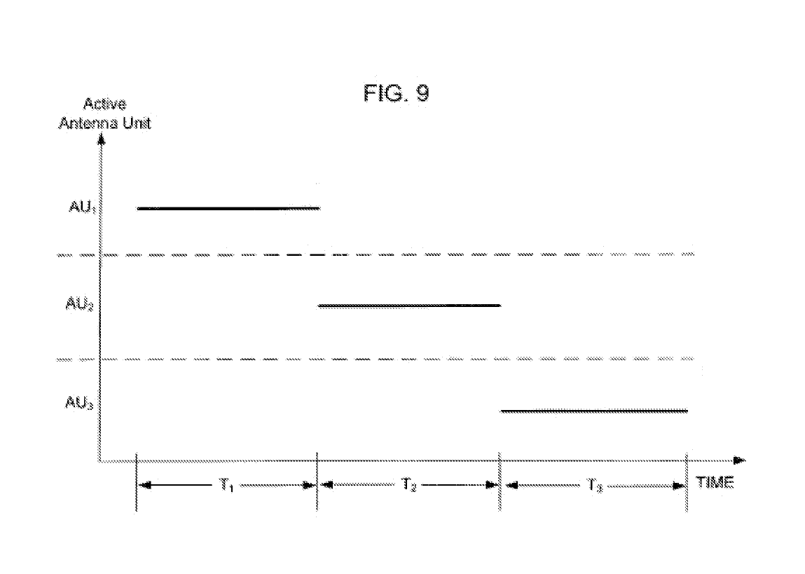

FIG. 9 illustrates an example of time sequence selection of antenna units for processing by a processing unit, not meant as any limitation. In this example, each antenna unit, AU₁, AU₂, AU₃ is sequentially selected for processing by downconverted signal processor, 703. A processing antenna unit can be substituted for anyone of the antenna units. Alternative selection timing options may be utilized, for example but not limited to, based on required priority of an antenna unit. Priority may be determined by, but not limited to, the number of detection zones an antenna unit has, the vehicle mounting location of an antenna unit or a high threat level occurring in an antenna unit's coverage area. For example, a high threat level in the front of a vehicle may result in selecting a front side mounted antenna unit for multiple sequential time periods. By providing priority for one or a plurality of antenna units as needed and by utilizing intertwined waveform transmission dead time risk due to sequential selection of antenna units as compared to simultaneous operation of multiple integrated sensors can be reduced. Furthermore, not meant as any limitation, an antenna unit may be selected only when the vehicle is in certain modes of operation. For example, not meant as any limitation, a rear-mounted backup sensor may be selected only while a vehicle is backing up or side-mounted blind spot sensors may be used only while driving forward.

If an antenna unit utilizes multiple non-concurrent detection zones, then the antenna unit will need to be selected for each of its detection zones. This selection may be performed sequentially or one or more antenna units may be selected in between. For example, not meant as any limitation, FIG. 9 can be modified to illustrate a two-antenna-unit embodiment, where the first antenna unit has two detection zones, A and B and the second antenna unit has a single detection zone and antenna unit selections AU₁, AU₂, AU₃, is instead AU_{1A}, AU_{1B}, AU₂. Furthermore, for a downconverted signal processor embodiment such as shown in FIG. 7C, a plurality of antenna units may be selected simultaneously and sequenced with one or a plurality of additional antenna units.

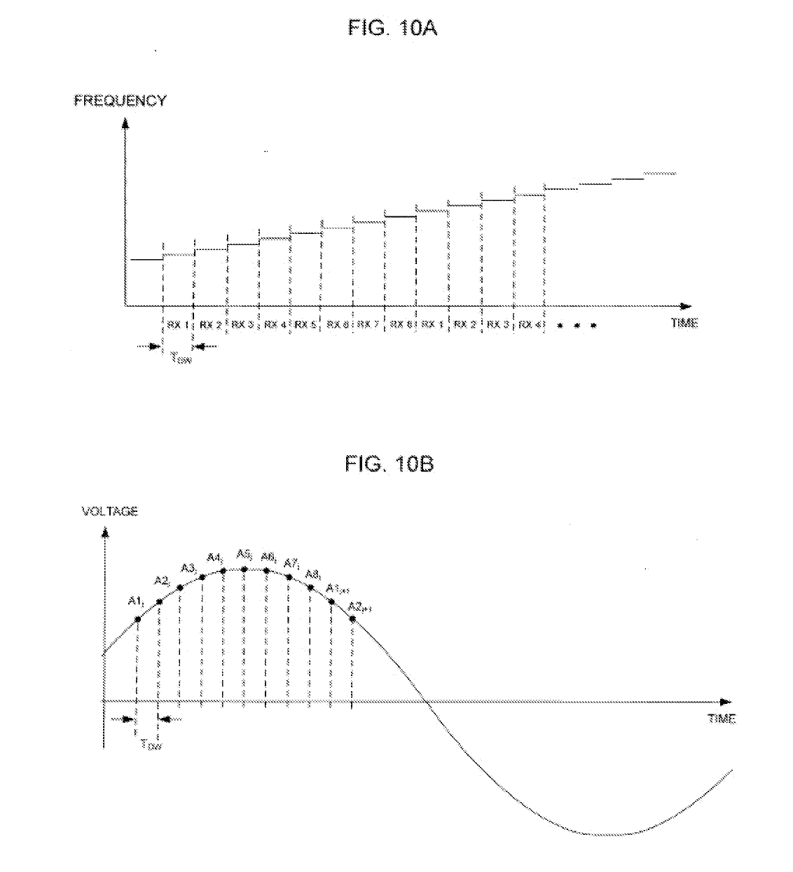

FIG. 10A illustrates one example of timing of receiver antenna selection for use with a linearly frequency stepped modulation waveform, compatible with the spatially separated signals processing methods according to aspects of the present invention. According to this example, the spatially separated receiver antennas RX 1 . . . RX n from FIG. 6A with n=8 are sequentially selected with respect to time. Each antenna is selected for a period of time denoted T_{DW}, during which the selected antenna is connected with the receiver/down-converter. During this period of time T_{DW}, an A/D sample is taken of the down-converted signal by downconverted signal processor 703, and stored. A typical value of T_{DW} can be within, but is not limited to, the range of 100 nanoseconds (ns)-100 microseconds (μs). After all n receiver antennas are sequenced through, the sequence is repeated for the duration of the coherent processing time period T_{P} of the stepped frequency modulation waveform. The stored digital samples of the down-converted signals during this period T_{P} are grouped separately for each corresponding receiver antenna to create a sequence of time-ordered samples of the down-converted signals for each receiver antenna spatial position, and will be used as part of a spatially separated signals processing method. The sequence of antenna selection may be varied for subsequent coherent processing intervals for advantage provided that the stored digital samples are grouped separately for each corresponding receiver antenna. Furthermore, a subset of the antennas may be selected for advantage. For the antenna unit arrangement as shown in FIG. 6B, FIG. 10A can be modified to show the timing of transmit antenna switching instead of receive antenna switching.

FIG. 10B illustrates an example of a down-converted target signal and A/D sample timing consistent with the stepped frequency modulation waveform and receiver antenna sequencing method described in FIG. 10A. The A/D sample values of the down-converted signal are illustrated by the black dots and are labeled Anⱼ, where n is an integer from 1 to 8, in this example representing the receiver antenna number RX n, and j is an integer from 1 to N−1, representing the A/D sample number within an N-point sample sequence. For this example, let N=256 samples during one coherent processing time period T_{P}. As can be seen, each successive A/D sample is delayed in time with respect to the preceding A/D sample by a time equal to T_{DW}, and occurs at a different phase on the down-converted target signal. For spatially separated signals processing methods that utilize complex signal phase, it is advantageous to utilize digitized down-converted signals which have the difference in A/D sample timing between them compensated. Since the difference in sample timing between adjacently selected receiver antenna means is equal to a time delay T_{DW}, this can be compensated for in the complex frequency domain as a frequency-dependent phase shift. As an example, let each digitized sample sequence Anⱼ of the down-converted signals during the period T_{P} be grouped separately for each corresponding receiver antenna and ordered in time. Let each separate sequence corresponding to each receiver antenna be processed separately by an N-point complex FFT. The difference in sample timing between each receiver antenna FFT sequence can be compensated by applying the phase shift in the following equation to the complex frequency points in the FFT sequence:
ΔΨ=2·π·fⱼ·ΔTₖ (6)
where fⱼ is the frequency of the jth position in the FFT sequence, j is an integer between 1 and N−1 for an N-point FFT sequence, and ΔTₖ is the difference in time between the sample time of receiver antenna 1 and the kth receiver antenna in the receiver antenna selection sequence.

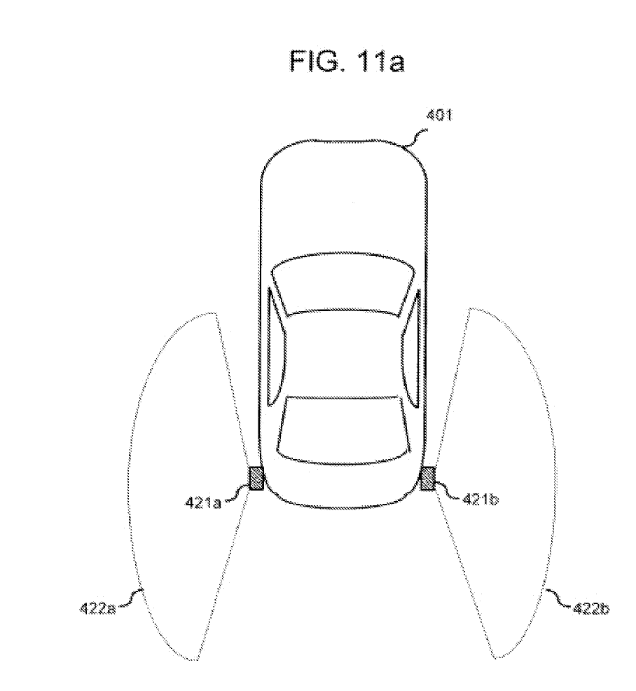

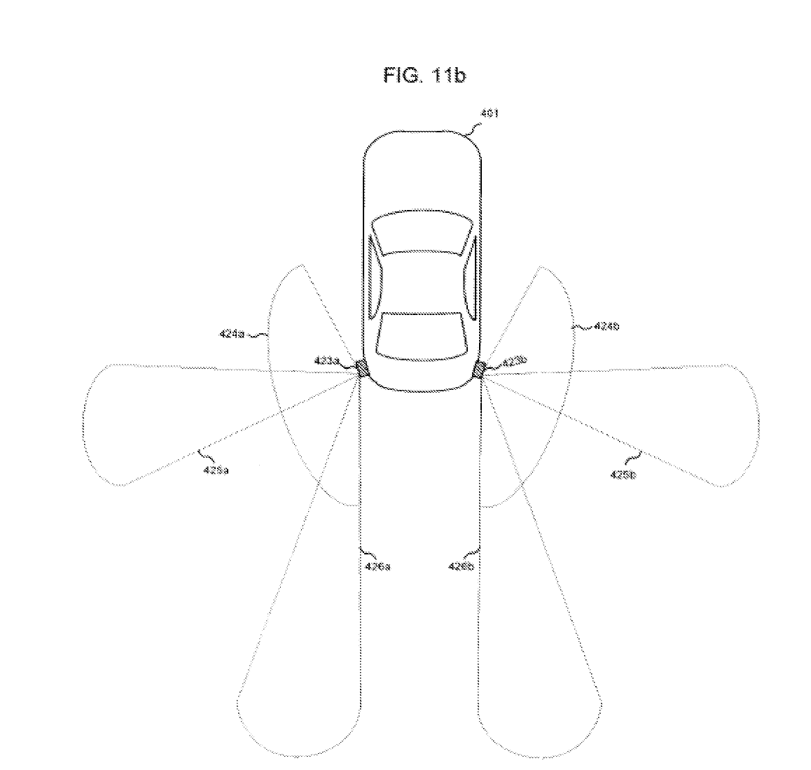

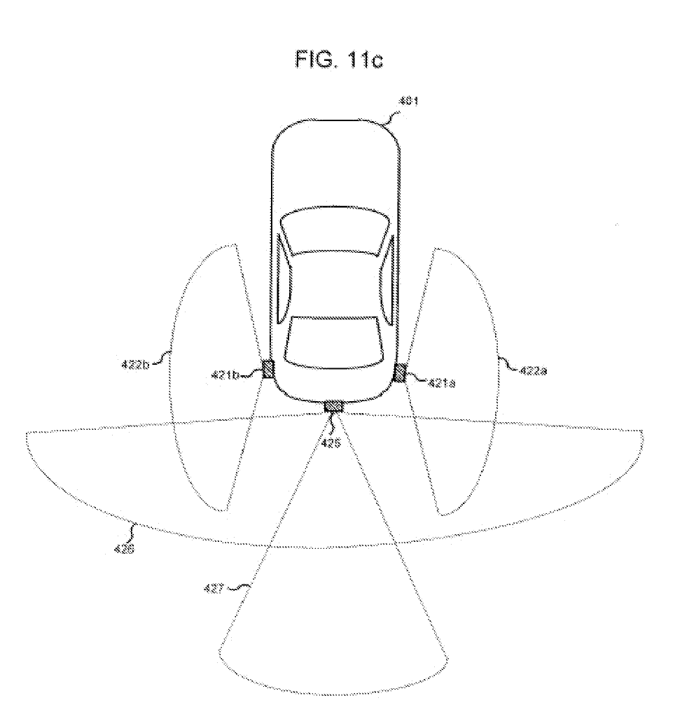

FIG. 11A illustrates one example of vehicle placement of antenna units or a processing antenna unit for vehicle blind spot coverage, and their corresponding detection zones, not meant as any limitation. In the example shown, both 421a and 421b may be antenna units, or one of 421a or 421b may be a processing antenna unit. Detection zones 422a and 422b provide detection of objects in the vehicle's corresponding left and right side blind spots.

FIG. 11B illustrates another example of vehicle placement of antenna units or a processing antenna unit for vehicle utilized for blind spot, lane change and crossing traffic coverage, not meant as any limitation. In the example shown, both 423a and 423b may be antenna units, or one of 423a or 423b may be a processing antenna unit. In the example shown, detection zones 424a and 424b are utilized for blind spot detection, detection zones 426b and 426c are utilized for change lane detection to identify vehicles that are for example closely behind or rapidly approaching on either side. The angled placement of 423a and 423b on the vehicle helps extend the range of coverage of the adjacent lanes by detection zones 426a and 426b. Detection zones 425a and 425b may be utilized for example for detection of crossing traffic while backing out of a parking spot.

FIG. 11C illustrates yet another example of vehicle placement of antenna units or a processing antenna unit, not meant as any limitation. In this example, 421a, 421b or 425 may all be antenna units, or anyone of these may be a processing antenna unit. This example illustrates blind spot coverage, as shown in FIG. 11A. In addition, 425 provides rear and extended side coverage. For example, not meant as any limitation, detection zone 426 may be utilized while the vehicle is backing up to detect objects behind the vehicle or objects that may be approaching from either side. Detection zone 427 may be utilized for detecting objects further in the rear while backing up or may be used while driving forward to detect another vehicle that is threatening to rear-end the current vehicle and enable appropriate warning or automated pre-collision actions be taken.

Similar placement of antenna units/processing units may be utilized in the front of the vehicle with the same or different detection zones. Furthermore, front rear and sides may be covered in combination by a single antenna unit network that may or may not include a processing antenna unit. In addition, a plurality of separate antenna networks may be utilized.

The preceding concepts, methods, and architectural elements described are meant as illustrative examples of aspects of the present invention, not as a limitation. Different combinations of these concepts, methods, and architectural elements than those described in the preceding figures can be utilized by one of ordinary skill in the art without departing from the spirit of the present invention.

What is claimed is:

1. A method for determining the characteristics of a target, comprising:
up-converting and transmitting a transmission signal from each of a plurality of spatially separated antenna units, each of said antenna units transmitting and/or receiving over an independent region;
receiving and down-converting a reflected portion of said transmission signal from each of said antenna units to generate a plurality of down-converted signals; and
distributing said down-converted signals to one or a plurality of processing units.

2. The method of claim 1, wherein said antenna units each comprise an antenna network, an up-converting means, and a down-converting means.

3. The method of claim 1, wherein one or more of said processing units are located separately from said antenna units.

4. The method of claim 1, wherein one or more of said processing units are located within one or more antenna units.

5. The method of claim 1, wherein said independent region for one of said two or more antenna units is different from said independent region for a second of said antenna units.

6. The method of claim 1, wherein said independent region for one of said two or more antenna units is the same as said independent region for a second of said antenna units.

7. The method of claim 1, wherein said characteristics of a target are determined for an automotive radar application.

8. The method of claim 1, wherein said characteristics of a target include at least one of target direction, target range, or target velocity.

9. The method of claim 1, wherein said transmission signal is frequency modulated.

10. The method of claim 2, wherein said antenna network comprises a plurality of spatially separated antennas.

11. The method of claim 1, wherein said distributed down-converted signals are analog signals.

12. The method of claim 1, wherein said down-converted signals are digitized prior to distribution to said signal processing units.

13. The method of claim 1, wherein said transmitting of said transmission signal by said antenna units is performed in a time-interleaved manner.

14. The method of claim 1, wherein said down-converting of a received reflected portion of said transmission signal by said antenna units is performed in a time-interleaved manner.

15. The method of claim 1, wherein each said independent region consists of a plurality of sub-regions.

16. The method of claim 15, wherein said sub-regions are selected in a time-interleaved manner.

17. The method of claim 1, wherein the number of said processing units is less than the number of said antenna units.

18. An apparatus for determining the characteristics of a target, comprising:
a plurality of spatially separated antenna units, wherein each of said antenna units comprises an integrated housing comprising means for up-converting and transmitting a transmission signal, means for receiving and down-converting a reflected portion of said transmission signal to generate a down-converted signal, and means for distributing said down-converted signal to one or a plurality of processing units, wherein each of said spatially separated antenna units transmits and/or receives over an independent region.
